(19) United States
(12) Patent Application Publication
(10) Pub. No.: US 2017/0282129 A1
(43) Pub. Date: Oct. 5, 2017

(54) COMPOSITE SEMIPERMEABLE MEMBRANE AND METHOD FOR PRODUCING THE SAME, SPIRAL WOUND SEPARATION MEMBRANE ELEMENT

(71) Applicant: NITTO DENKO CORPORATION, Osaka (JP)

(72) Inventors: Kazusa MATSUI, Osaka (JP); Masashi ECHIZEN, Osaka (JP); Atsuko MIZUIKE, Osaka (JP); Taisuke YAMAGUCHI, Osaka (JP)

(73) Assignee: NITTO DENKO CORPORATION, Osaka (JP)

(21) Appl. No.: 15/514,282

(22) PCT Filed: Sep. 28, 2015
(86) PCT No.: PCT/JP2015/077366

§ 371 Date: Mar. 24, 2017

(30) Foreign Application Priority Data
Sep. 30, 2014 (JP) 2014-200657

(51) Int. Cl. B01D 69/12; B01D 65/00; B01D 71/56; B01D 63/10; B01D 71/48

(52) U.S. Cl. CPC B01D 69/125; B01D 63/10; B01D 71/48; B01D 71/56; B01D 65/003; B01D 2313/04; B01D 2325/04

(57) ABSTRACT

The purpose of the present invention is to provide: a thin composite semipermeable membrane having a practical salt rejection and permeation flux; a method for producing said membrane; and a spiral wound separation membrane element that has a practical salt rejection and provides excellent water treatment efficiency. The method for producing the composite semipermeable membrane includes a step in while, while feeding out a porous support having a porous polymer layer on one surface of a nonwoven fabric layer from a supply roll, an amine solution containing a multifunctional amine component is brought into contact with the porous support, and an organic solution containing a multifunctional acid halide component is brought into contact with the amine solution on the porous support to cause interfacial polymerization, thus forming a skin layer containing a polyamide resin on the surface of the porous support.

### TECHNICAL FIELD

The present invention relates to a composite semipermeable membrane wherein a skin layer containing a polyamide resin is formed on the surface of a porous support, and a method for producing the same, and a spiral wound separation membrane element using the composite semipermeable membrane. The composite semipermeable membrane and the spiral wound separation membrane element are suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the membrane can be used for concentration of active ingredients in foodstuffs usage, for an advanced water treatment, such as removal of harmful component in water purification and sewage usage etc. Moreover, the membrane can be used for waste water treatment in oil fields or shale gas fields.

### BACKGROUND ART

The composite semipermeable membrane is called an RO (reverse osmosis) membrane, an NF (nanofiltration) membrane, or a FO (forward osmosis) membrane, depending on the filtration performance and treatment method of the membrane, and such membrane can be used for the production of ultrapure water, seawater desalination, desalination of brackish water, waste water recycling treatment, or the like.

Currently, composite semipermeable membranes, in which a skin layer including a polyamide resin obtained by interfacial polymerization of a polyfunctional amine and a polyfunctional acid halide is formed on a porous support, have been proposed (Patent Document 1).

The composite semipermeable membrane is usually processed into a spiral wound separation membrane element and used for water treatment and the like. For example, a spiral wound separation membrane element is known, the spiral wound separation membrane element including a unit that is formed of a feed spacer that guides a feed-side fluid to the surface of a separation membrane, a separation membrane that separates the feed-side fluid, and a permeate spacer that guides to the core tube a permeation-side fluid separated from the feed-side fluid by permeating through the separation membrane, and is wound around a perforated core tube (Patent Documents 2 and 3).

Until now, various studies have been made to improve the water treatment efficiency of a spiral wound separation membrane element. However, it has been difficult to improve the water treatment efficiency while maintaining a practical salt rejection.

### PRIOR ART DOCUMENTS

### Patent Documents

Patent Document 1: JP-A-2005-103517

Patent Document 2: JP-A-2000-354743

Patent Document 3: JP-A-2006-68644

### SUMMARY OF THE INVENTION

### Problems to be Solved by the Invention

An object of the present invention is to provide a thin composite semipermeable membrane having a practical salt rejection and a practical permeation flux, a method for producing the membrane, and a spiral wound separation membrane element that has a practical salt rejection and provides excellent water treatment efficiency.

### Means for Solving the Problems

The present inventors have conducted extensive studies to achieve the above object, and, as a result, found that a thin composite semipermeable membrane having a practical salt rejection and a practical permeation flux can be obtained by the following production method. The present invention has been completed based on these findings.

That is, the present invention relates to a method for producing a composite semipermeable membrane, comprising a step of, while feeding out a porous support having a porous polymer layer on one surface of a nonwoven fabric layer from a supply roll, bringing an amine solution containing a multifunctional amine component into contact with the porous support, and bringing an organic solution containing a multifunctional acid halide component into contact with the amine solution on the porous support to cause interfacial polymerization so that a skin layer containing a polyamide resin is formed on a surface of the porous support, wherein the nonwoven fabric layer is 50 to 90 μm thick, and the amine solution is brought into contact with the porous support when the rate of decrease of the moisture content of the porous support is within 15% relative to 100% that is the moisture content of the porous support when being fed out from the supply roll.

Also, the another present invention relates to a method for producing a composite semipermeable membrane, comprising a step of, while feeding out a porous support having a porous polymer layer on one surface of a nonwoven fabric layer from a supply roll, bringing an amine solution containing a multifunctional amine component into contact with the porous support, and bringing an organic solution containing a multifunctional acid halide component into contact with the amine solution on the porous support to cause interfacial polymerization so that a skin layer containing a polyamide resin is formed on a surface of the porous support, wherein

the nonwoven fabric layer is 50 to 90 μm thick, and

the rate of decrease of the moisture content of the porous support when the amine solution is brought into contact with the porous support is maintained within 15% relative to 100% that is the moisture content of the porous support when being fed out from the supply roll.

As a method for improving the water treatment efficiency without changing the size of the spiral wound separation membrane element, for example, there is a method of incorporating a larger number of composite semipermeable membranes into such element to increase the effective membrane area per unit volume of the element. As a method of incorporating a larger number of composite semipermeable membranes into the spiral wound separation membrane element, for example, there is a method of using a thin composite semipermeable membrane. In order to produce a thin composite semipermeable membrane, it is considered effective to use a thin nonwoven fabric layer which is relatively large in thickness. However, when a thin nonwoven fabric layer is used, there is a problem that the salt rejection and the permeation flux of the composite semipermeable membrane are greatly reduced. As a result of intensive studies on the causes of this reduction, the present inventors have found that the moisture content in a porous support when a skin layer is formed on the porous support greatly affects the salt rejection and the permeation flux. Specifically, the porous support is usually used in a wet state to prevent the amine solution from being repelled. The porous support wound around the supply roll contains a sufficient amount of moisture, but when the porous support is fed out from the supply roll and conveyed, moisture gradually evaporates from the porous support, resulting in gradual decrease of the moisture content of the porous support. In the case of using a conventional thick porous support, since the decrease of the moisture content during conveyance is not so large, such a thick porous support contains a sufficient amount of moisture even when the amine solution is applied onto the porous support. However, in the case of using a thin porous support, since the moisture content greatly decreases during conveyance, the moisture content of the porous support becomes insufficient when the amine solution is applied onto the porous support. Therefore, the polyfunctional amine component hardly permeates into the porous support, and the polymerization reaction between the polyfunctional amine component and the polyfunctional acid halide component does not proceed sufficiently inside the porous support. As a result, the skin layer is not sufficiently formed on the porous support, and a flat skin layer having no pleat is formed on the surface of the porous support, so that the salt rejection and the permeation flux are considered to be greatly decreased.

The present inventors have found that a composite semipermeable membrane having a practical salt rejection and a practical permeation flux can be obtained even when a thin porous support is used by bringing the amine solution into contact with the porous support when the rate of decrease of the moisture content of the porous support is within 15% relative to 100% that is the moisture content of the porous support when being fed out from the supply roll, or by maintaining the rate of decrease of the moisture content of the porous support within 15% relative to 100% when the amine solution is brought into contact with the porous support.

The porous polymer layer is preferably 10 to 35 μm thick.

Also, the present invention relates to a composite semipermeable membrane obtained by the said production method, and a spiral wound separation membrane element including the composite semipermeable membrane.

### Effect of the Invention

Although the composite semipermeable membrane of the present invention is thin, it has a practical salt rejection and a practical permeation flux. Since the spiral wound separation membrane element of the present invention includes the thin composite semipermeable membrane, the element incorporates a larger number of composite semipermeable membranes than the conventional one does. In other words, the spiral wound separation membrane element of the present invention is superior in water treatment efficiency because the effective membrane area per unit volume of the element is larger than that of the conventional one.

### MODE FOR CARRYING OUT THE INVENTION

Hereinafter, the embodiments of the present invention will be described. The method for producing the composite semipermeable membrane of the present invention, comprising a step of, while feeding out a porous support having a porous polymer layer on one surface of a nonwoven fabric layer from a supply roll, bringing an amine solution containing a multifunctional amine component into contact with the porous support, and bringing an organic solution containing a multifunctional acid halide component into contact with the amine solution on the porous support to cause interfacial polymerization so that a skin layer containing a polyamide resin is formed on a surface of the porous support. Hereinafter, the present invention will be described in detail.

First, an amine solution containing a polyfunctional amine component is brought into contact with a porous support while the porous support having a porous polymer layer on one surface of a nonwoven fabric layer is fed out from a supply roll.

The nonwoven fabric layer is not particularly limited as long as it imparts moderate mechanical strength while maintaining the separation performance and the permeation performance of the composite semipermeable membrane, and a commercially available nonwoven fabric can be used. Examples of the materials of such a nonwoven fabric include materials made of polyolefins, polyesters, cellulose or the like, and a mixture of a plurality of materials can also be used. In particular, from the viewpoint of formability, a polyester is preferably used. Moreover, a long-fiber nonwoven fabric or a short-fiber nonwoven fabric can be used as appropriate, but a long-fiber nonwoven fabric can be preferably used from the viewpoints of raised fabric causing pinhole defects, and uniformity of the membrane surface. Further, the air permeability of the nonwoven fabric layer alone is, but not limited to, about 0.5 to 10 cm³/cm²·s, preferably about 1 to 5 cm³/cm²·s.

Examples of the nonwoven fabric layer include one having a thickness of 90 μm or less from the viewpoint of producing a thin composite semipermeable membrane. The thickness of the nonwoven fabric layer is preferably 80 μm or less, more preferably 70 μm or less, even more preferably 65 μm or less, particularly preferably 60 μm or less. On the other hand, if the thickness of the nonwoven fabric layer is too small, the mechanical strength as a support decreases and thus it becomes difficult to obtain a stable composite semipermeable membrane. Accordingly, a nonwoven fabric layer having a thickness of 50 μm or more is used.

The porous polymer layer is not particularly limited as long as it can form the skin layer. However, the porous polymer layer is usually a microporous layer having a pore diameter of about 0.01 to 0.4 μm. Examples of the materials for forming the microporous layer can include various materials such as polysulfones, polyethersulfones exemplified by polyarylethersulfones, polyimides, and polyvinylidene fluorides. In particular, from the viewpoint of being chemically, mechanically and thermally stable, a porous polymer layer made from a polysulfone or a polyarylethersulfone is preferable.

Although the thickness of the porous polymer layer is not particularly limited, the thickness is preferably 35 μm or less, more preferably 32 μm or less, even more preferably 29 μm or less, particularly preferably 25 μm or less because the flux retention rate after pressurization is likely to decrease if the porous polymer layer is too thick. On the other hand, if the thickness of the porous polymer layer is too small, defects tend to occur. Accordingly, the thickness is preferably 10 μm or more, and more preferably 15 μm or more.

The production method in the case where the material for forming the porous polymer layer is a polysulfone will be illustrated. The porous polymer layer can be generally produced by a method called “wet method” or “dry-wet method”. For example, the porous polymer layer can be formed on a nonwoven fabric layer by a solution preparation step of mixing and dissolving a polysulfone, a solvent, and various additives to obtain a solution; a coating step of coating the nonwoven fabric layer with the solution; a drying step of evaporating the solvent in the applied solution to cause microphase separation; and an immobilization step of immobilizing the porous structure by immersion in a coagulation bath such as a water bath. The thickness of the porous polymer layer can be set by adjusting the solution concentration and the coating amount in consideration of the ratio of the porous polymer layer impregnated in the nonwoven fabric layer.

The amine solution contains at least a polyfunctional amine component.

The polyfunctional amine component is defined as a polyfunctional amine having two or more reactive amino groups, and includes aromatic, aliphatic, and alicyclic polyfunctional amines.

The aromatic polyfunctional amines include, for example, m-phenylenediamine, p-phenylenediamine, o-phenylenediamine, 1,3,5-triamino benzene, 1,2,4-triamino benzene, 3,5-diaminobenzoic acid, 2,4-diaminotoluene, 2,6-diaminotoluene, N,N′-dimethyl-m-phenylenediamine, 2,4-diaminoanisole, amidol, xylylene diamine etc.

The aliphatic polyfunctional amines include, for example, ethylenediamine, propylenediamine, tris(2-aminoethyl)amine, n-phenylethylenediamine, etc.

The alicyclic polyfunctional amines include, for example, 1,3-diaminocyclohexane, 1,2-diaminocyclohexane, 1,4-diaminocyclohexane, piperazine, 2,5-dimethylpiperazine, 4-aminomethyl piperazine, etc.

These polyfunctional amines may be used independently, and two or more kinds may be used in combination. In order to obtain a skin layer having a higher salt-rejecting property, it is preferred to use the aromatic polyfunctional amines.

Examples of the solvents for the amine solution include water, alcohols (e.g. ethanol, isopropyl alcohol, and ethylene glycol), and a mixed solvent of water and an alcohol.

Although the concentration of the polyfunctional amine component in the amine solution is not in particular limited, the concentration is preferably 0.1 to 5% by weight, and more preferably 0.5 to 2% by weight. Less than 0.1% by weight of the concentration of the polyfunctional amine component may easily cause defect such as pinhole. in the skin layer, leading to tendency of deterioration of salt-rejecting property. On the other hand, the concentration of the polyfunctional amine component exceeding 5% by weight allows easy permeation of the polyfunctional amine component into the porous support to be an excessively large thickness and to raise the permeation resistance, likely giving deterioration of the permeation flux.

In the production method of the present invention, the amine solution is brought into contact with the porous support when the rate of decrease of the moisture content of the porous support is within 15% relative to 100% that is the moisture content of the porous support when being fed out from the supply roll. It is preferred to bring the amine solution into contact with the porous support when the rate of decrease of the moisture content of the porous support is within 12%.

As a method of bringing the amine solution into contact with the porous support when the rate of decrease of the moisture content of the porous support is within 15%, there is mentioned, for example, a method of increasing the line speed compared to the conventional line speed because the rate of decrease of the moisture content of the thin porous support tends to exceed 15% when the amine solution is brought into contact with the thin porous support of the present invention during conveyance of the thin porous support at the conventional line speed (i.e. a line speed in the case of using a thick porous support). Specifically, it is preferable to convey the porous support at a speed 1.5 times or more the conventional line speed. Further, for example, the position at which the amine solution is brought into contact with the porous support may be changed to the front side (a position closer to the supply roll) of the conventional position.

Further, in the production method of the present invention, it is possible to adopt a method of maintaining the rate of decrease of the moisture content of the porous support when the amine solution is brought into contact with the porous support within 15% relative to 100% that is the moisture content of the porous support when being fed out from the supply roll. Preferably, the rate of decrease of the moisture content of the porous support is maintained within 12%. As a method for maintaining the rate of decrease of the moisture content of the porous support within 15%, there are mentioned, for example, a method of adding a surfactant or a humectant to the porous support, a method of increasing the humidity of the production line, and a method of blowing water onto the porous support during conveyance.

Thereafter, the amine solution on the porous support and the organic solution containing the polyfunctional acid halide component are brought into contact with each other to cause interfacial polymerization, thus forming a skin layer containing a polyamide resin on the surface of the porous support.

The polyfunctional acid halide component represents polyfunctional acid halides having two or more reactive carbonyl groups.

The polyfunctional acid halides include aromatic, aliphatic, and alicyclic polyfunctional acid halides.

The aromatic polyfunctional acid halides include, for example trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, chlorosulfonyl benzenedicarboxylic acid dichloride etc.

The aliphatic polyfunctional acid halides include, for example, propanedicarboxylic acid dichloride, butane dicarboxylic acid dichloride, pentanedicarboxylic acid dichloride, propane tricarboxylic acid trichloride, butane tricarboxylic acid trichloride, pentane tricarboxylic acid trichloride, glutaryl halide, adipoyl halide etc.

The alicyclic polyfunctional acid halides include, for example, cyclopropane tricarboxylic acid trichloride, cyclobutanetetracarboxylic acid tetrachloride, cyclopentane tricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofuran dicarboxylic acid dichloride, etc.

These polyfunctional acid halides may be used independently, and two or more kinds may be used in combination. In order to obtain a skin layer having higher salt-rejecting property, it is preferred to use aromatic polyfunctional acid halides. In addition, it is preferred to form a cross linked structure using polyfunctional acid halides having trivalency or more as at least a part of the polyfunctional acid halide components.

Furthermore, in order to improve performance of the skin layer including the polyamide resin, polymers such as polyvinyl alcohol, polyvinylpyrrolidone, and polyacrylic acids etc., and polyhydric alcohols, such as sorbitol and glycerin, may be copolymerized.

Although the concentration of the polyfunctional acid halide component in the organic solution is not in particular limited, it is preferably 0.01 to 5% by weight, and more preferably 0.05 to 3% by weight. Less than 0.01% by weight of the concentration of the polyfunctional acid halide component is apt to make the unreacted polyfunctional amine component remain, to cause defect such as pinhole in the skin layer, leading to tendency of deterioration of salt-rejecting property. On the other hand, the concentration exceeding 5% by weight of the polyfunctional acid halide component is apt to make the unreacted polyfunctional acid halide component remain, to be an excessively large thickness and to raise the permeation resistance, likely giving deterioration of the permeation flux.

The organic solvents used for the organic solution is not especially limited as long as they have small solubility to water, and do not cause degradation of the porous support, and dissolve the polyfunctional acid halide component. For example, the organic solvents include saturated hydrocarbons, such as cyclohexane, heptane, octane, and nonane, halogenated hydrocarbons, such as 1,1,2-trichlorofluoroethane, etc. It is preferable to use an organic solvent having a boiling point of 300° C. or less, more preferable to use an organic solvent having a boiling point of 200° C. or less.

Various kinds of additives may be added to the amine solution or the organic solution in order to provide easy film production and to improve performance of the composite semipermeable membrane to be obtained. The additives include, for example, surfactants, such as sodium dodecylbenzenesulfonate, sodium dodecyl sulfate, and sodium lauryl sulfate; basic compounds, such as sodium hydroxide, trisodium phosphate, triethylamine, etc. for removing hydrogen halides formed by polymerization; acylation catalysts; compounds having a solubility parameter of 8 to 14 (cal/cm³)^{1/2} described in Japanese Patent Application Laid-Open No. H08-224452.

The period of time after application of the amine solution until application of the organic solution on the porous support depends on the composition and viscosity of the amine solution, and on the pore size of the surface layer of the porous support, and it is preferably 15 seconds or less, and more preferably 5 seconds or less. Application interval of the solution exceeding 15 seconds may allow permeation and diffusion of the amine solution to a deeper portion in the porous support, and possibly cause a large amount of the residual unreacted polyfunctional amine components in the porous support. In this case, removal of the unreacted polyfunctional amine component that has permeated to the deeper portion in the porous support is probably difficult even with a subsequent membrane washing treatment. Excessive amine solution may be removed after covering by the amine solution on the porous support.

In the present invention, after the contact with the amine solution and the organic solution, it is preferred to remove the excessive organic solution on the porous support, and to dry the formed membrane on the porous support by heating at a temperature of 70° C. or more, forming the skin layer. Heat-treatment of the formed membrane can improve the mechanical strength, heat-resisting property, etc. The heating temperature is more preferably 70 to 200° C., and especially preferably 100 to 150° C. The heating period of time is preferably approximately 30 seconds to 10 minutes, and more preferably approximately 40 seconds to 7 minutes.

The thickness of the skin layer formed on the porous support is not in particular limited, and it is usually approximately 0.01 to 100 μm, and preferably 0.1 to 10 μm.

There is no limitation on the shape of the composite semipermeable membrane of the present invention. That is, the composite semipermeable membrane can take any conceivable membrane shapes, such as a flat membrane or a spiral element. Further, conventionally known various treatments may be applied to the composite semipermeable membrane so as to improve its salt-rejecting property, water permeability, and oxidation resistance.

The spiral wound separation membrane element of the present invention is produced, for example, by stacking a permeate spacer onto a material obtained by disposing a feed spacer between two sheets of a two-folded composite semipermeable membrane; applying an adhesive on the composite semipermeable membrane peripheral parts (three sides) so as to form sealing parts for preventing the feed-side fluid and the permeation-side fluid from being mixed with each other, thereby to prepare a separation membrane unit; winding one of the unit or a plurality of the units in a spiral form around a core tube, and further sealing the separation membrane unit peripheral parts.

### EXAMPLE

The present invention will, hereinafter, be described with reference to Examples, but the present invention is not limited at all by these Examples.

### [Evaluation and Measurement Method]

### (Measurement of Moisture Content of Porous Support)

A porous support immediately after being fed out from a supply roll was cut off to prepare a sample, and the weight X₁ of the sample was measured. Thereafter, the sample was dried and the weight Y₁ of the dried sample was measured. The moisture content A (%) of the porous support immediately after being fed out from the supply roll was calculated by the following formula.

Moisture content A (%)=[(Weight X₁−Weight Y₁)/(Weight X₁)]×100

In addition, the porous support immediately before being brought into contact with the amine solution was cut off to prepare a sample, and the weight X₂ of the sample was measured. Thereafter, the sample was dried and the weight Y₂ of the dried sample was measured. The moisture content B (%) of the porous support immediately before being brought into contact with the amine solution was calculated by the following formula.

Moisture content B (%)=[(Weight X₂−Weight Y₂)/(Weight X₂)]×100

In addition, the rate of decrease of the moisture content was calculated by the following formula.

Rate (%) of decrease of moisture content=[(Moisture content A−Moisture content B)/(Moisture content A)]×100

### (Measurement of Permeation Flux and Salt-Rejection)

The prepared flat shape composite semipermeable membrane was cut into a predetermined shape and size, and was set to a cell for flat shape evaluation. An aqueous solution containing 0.2% MgSO₄ and being adjusted to pH 7 with NaOH was allowed to contact to a supply side and permeation side of the membrane at a differential pressure of 1.5 Mpa at 25° C. A permeation velocity and electric conductivity of the permeated water obtained by this operation were measured, and a permeation flux (m³/m²·d) and a salt-rejection (%) were calculated. The correlation (calibration curve) of the MgSO₄ concentration and electric conductivity of the aqueous solution was made beforehand, and the salt-rejection was calculated by the following equation.

Salt-rejection (%)={1−(MgSO₄ concentration in permeated liquid [mg/L])/(MgSO₄ concentration in supply solution) [mg/L]}×100

### Example 1

A mixed solution containing a polysulfone and dimethylformamide was applied onto the surface of a nonwoven fabric layer having a thickness of 65 μm and coagulated to form a porous polymer layer having a thickness of 25 μm, whereby a porous support was prepared. The porous support was then wound on a supply roll. An amine solution was prepared by dissolving 3.6% by weight of piperazine hexahydrate and 0.15% by weight of sodium lauryl sulfate in water. Further, an organic solution was prepared by dissolving 0.4% by weight of trimesic acid chloride in hexane. The prepared amine solution was applied onto the porous support while the porous support was fed out from a supply roll at a speed 1.5 times faster than the normal line speed, and the prepared organic solution was further applied onto the porous support. Thereafter, the excessive solution was removed and the porous support was further kept in a hot air dryer at 100° C. for 5 minutes to form a skin layer containing a polyamide resin on the porous support, whereby a composite semipermeable membrane was prepared.

### Comparative Example 1

A composite semipermeable membrane was prepared in the same manner as in Example 1, except that the porous support was fed out from the supply roll at the normal line speed.

### Comparative Example 2

A composite semipermeable membrane was produced in the same manner as in Example 1, except that the porous support was fed out from the supply roll at a speed 1.2 times faster than the normal line speed.

### Comparative Example 3

A mixed solution containing a polysulfone and dimethylformamide was applied onto the surface of a nonwoven fabric layer having a thickness of 100 μm and coagulated to form a porous polymer layer having a thickness of 45 μm, whereby a porous support was prepared. The porous support was then wound on a supply roll. A composite semipermeable membrane was prepared in the same manner as in Example 1, except that the porous support was used and fed out from the supply roll at the normal line speed.

TABLE 1

| | Thickness | | | Rate of | | |
|---|---|---|---|---|---|---|
| | of nonwoven | Thickness | | decrease | | |
| | fabric | of porous | Ratio of | of moisture | Salt | Permeation |
| | layer | support | line speed | content | rejection | flux |
| | (μm) | (μm) | (Normally 1.0) | (%) | (%) | (m³/m² · d) |
| Example 1 | 65 | 90 | 1.5 | 11.2 | 99.76 | 1.23 |
| Comparative | 65 | 90 | 1.0 | 19.5 | 97.94 | 0.88 |
| Example 1 | | | | | | |
| Comparative | 65 | 90 | 1.2 | 16.9 | 99.17 | 0.83 |
| Example 2 | | | | | | |
| Comparative | 100 | 145 | 1.0 | 8.7 | 99.88 | 1.29 |
| Example 3 | | | | | | |

### INDUSTRIAL APPLICABILITY

The composite semipermeable membrane and spiral wound separation membrane element of the present invention are suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the element can be used for concentration of active ingredients in foodstuffs usage, for an advanced water treatment, such as removal of harmful component in water purification and sewage usage etc. Moreover, the element can be used for waste water treatment in oil fields or shale gas fields.

1. A method for producing a composite semipermeable membrane, comprising a step of, while feeding out a porous support having a porous polymer layer on one surface of a nonwoven fabric layer from a supply roll, bringing an amine solution containing a multifunctional amine component into contact with the porous support, and bringing an organic solution containing a multifunctional acid halide component into contact with the amine solution on the porous support to cause interfacial polymerization so that a skin layer containing a polyamide resin is formed on a surface of the porous support, wherein
the nonwoven fabric layer is 50 to 90 μm thick, and
the amine solution is brought into contact with the porous support when the rate of decrease of the moisture content of the porous support is within 15% relative to 100% that is the moisture content of the porous support when being fed out from the supply roll.

2. A method for producing a composite semipermeable membrane, comprising a step of, while feeding out a porous support having a porous polymer layer on one surface of a nonwoven fabric layer from a supply roll, bringing an amine solution containing a multifunctional amine component into contact with the porous support, and bringing an organic solution containing a multifunctional acid halide component into contact with the amine solution on the porous support to cause interfacial polymerization so that a skin layer containing a polyamide resin is formed on a surface of the porous support, wherein
the nonwoven fabric layer is 50 to 90 μm thick, and
the rate of decrease of the moisture content of the porous support when the amine solution is brought into contact with the porous support is maintained within 15% relative to 100% that is the moisture content of the porous support when being fed out from the supply roll.

3. The method for producing a composite semipermeable membrane according to claim 1, wherein the porous polymer layer is 10 to 35 μm thick.

4. A composite semipermeable membrane obtained by the production method according to claim 1.

5. A spiral wound separation membrane element comprising the composite semipermeable membrane according to claim 4.

6. The method for producing a composite semipermeable membrane according to claim 2, wherein the porous polymer layer is 10 to 35 μm thick.

7. A composite semipermeable membrane obtained by the production method according to claim 2.

8. A composite semipermeable membrane obtained by the production method according to claim 3.

9. A composite semipermeable membrane obtained by the production method according to claim 6.

10. A spiral wound separation membrane element comprising the composite semipermeable membrane according to claim 7.

11. A spiral wound separation membrane element comprising the composite semipermeable membrane according to claim 8.

12. A spiral wound separation membrane element comprising the composite semipermeable membrane according to claim 9.
